(19) United States
(12) Patent Application Publication
(10) Pub. No.: US 2005/0020106 A1
(43) Pub. Date: Jan. 27, 2005

(54) Electrical connection box

(75) Inventor: Katsuya Ito, Yokkaichi-city (JP)

Correspondence Address: GREENBLUM & BERNSTEIN, P.L.C., 1950 ROLAND CLARKE PLACE, RESTON, VA, 20191, US

(73) Assignee: Sumitomo Wiring Systems, Ltd., Yokkaichi-city (JP)

(21) Appl. No.: 10/896,111

(22) Filed: Jul. 22, 2004

(30) Foreign Application Priority Data
Jul. 23, 2003 (JP) 2003-200248

(51) Int. Cl. H01R 12/00

(52) U.S. Cl. 439/76.2

(57) ABSTRACT

An electrical connection box has a configuration in which fuse sections of bus bars integrated with fusible links housed in parallel alignment can be visually inspected with ease. The bus bars are positioned with space therebetween so that a bus bar closest to a peripheral wall of the case is placed at a lowest position and that the inner bus bars are placed at higher positions. A cut-out section is provided on an upper edge of a peripheral wall of the case so that the position of the cut-out section opposes the fuse sections of the bus bar at the lowest position.

### BACKGROUND OF THE INVENTION

1. Field of the Invention

The present invention relates to an electrical connection box, and more particularly, to an electrical connection box in which a plurality of bus bars integrated with fusible links are provided in parallel alignment such that determination of blown fuse sections may be confirmed from outside the case with ease.

2. Description of the Background Information

As FIG. 6 illustrates, electrical connection boxes mounted on automobiles may house bus bars integrated with fusible links 1. The bus bars may be manufactured by stamping out a piece of bus bar 2, and integrally providing fuse sections 5. The fuse sections 5 include a plurality of narrow sections, each located between one of a plurality of output terminals 4 and input terminal 3 connected to a battery. An example of a known bus bar is described in Japanese Patent Application Publication No. 2002-52433.

A bus bar 1 with the above configuration must be removed from an electrical connection box to determine whether or not any of fuse sections 5 has melted or “blown”. Therefore, confirming the state of the fuse sections 5 takes time and labor. In addition, when there are many terminals, a large force is required to remove bus bar 1. Moreover, there is a concern that output terminals 4 and their counterpart terminals may be bent when a bus bar is removed.

Moreover, when there are a plurality of bus bars 1a and 1b in case 6, as shown in FIG. 7, each of the bus bars 1a and 1b must be removed from case 6 in order to confirm whether or not any of fuse sections 5 has blown. Further, dividing wall 7 is provided between bus bars 1a and 1b. When LA terminal 8 is to be connected to input terminal 3a, formed on bus bar 1a, it is necessary to form the dividing wall 7 in such a way that it extends farther out than the point where pressure contact section 8a of LA terminal 8 is located in order to prevent fire hazards. The presence of the dividing wall 7 makes it more difficult to reach input terminal 3b on bus bar 1b next to bus bar 1a, to which LA terminal 8 is connected. Thus, dividing wall 7 interferes with the operation of connecting input terminal 3b and its counterpart terminal 9.

### SUMMARY OF THE INVENTION

Upon giving consideration to the disadvantages in the prior art, the present invention provides an electrical connection box in which determination of whether or not any of the fuse sections of a bus bar integrated with fusible links, in particular bus bars integrated with fusible links installed in a parallel alignment, has blown can be accomplished by visual inspection with ease from outside of the electrical connection box. Further, the present invention facilitates a simpler operation to make connections to each bus bar in the electrical connection box.

The present invention provides an electrical connection box which is configured to include a plurality of bus bars integrated with fusible links having narrow fuse sections integrally formed with a conductive metal plate. The bus bars are housed in the vertical orientation in a case; the fuse sections of all bus bars are positioned on one side of the case; and a cover is closed over an upper surface of the case; and the bus bars are installed in parallel alignment with vertical displacement therebetween so that a bus bar closest to a peripheral wall of the case is positioned at the lowest position and that additional inner bus bars are placed at higher positions. Further, a cut-out section is provided on an upper edge of a peripheral wall of the case so that the position of the cut-out section opposes the fuse sections of the bus bar at the lowest position; and the fuse sections of the bus bars can be visually inspected from outside of the case.

When a plurality of bus bars are arranged with vertical displacements so that a bus bar closer to the inner side of the case is positioned higher than one closer to the peripheral case wall, it is easier to visually inspect fuse sections of the bus bars placed closer to the inner side of the case through the small gaps between the bus bars. Moreover, a cut-out section provided on the peripheral case wall enables fuse sections of bus bars closer to the peripheral wall to be visually inspected. Therefore, merely removing the cover facilitates visual inspection of whether or not any of the fuse sections of the bus bars from the peripheral case wall side to the inner side of the case has blown. Therefore, removing the bus bars from the case is unnecessary. Thus, the labor and time required for the operation to confirm whether or not any of the fuse sections of the bus bars has blown are reduced while quality is improved by preventing terminal deformations caused during bus bar removal.

Moreover, a dividing wall may be provided between bus bars. Installing bus bars in parallel alignment with vertical displacements enables the dividing wall to extend a shorter distance with respect to an adjacent bus bar. Therefore, the dividing wall does not interfere with the operation of connecting bus bars to other circuits, and terminals can be inserted with ease.

A gap between the bus bars are designed to be small by entirely or mostly overlapping the fuse sections of a bus bar closer to an inner side of the case with those of an adjacent bus bar closer to a peripheral wall of the case in the vertical direction. When the gap is narrow, the displacements are designed to be large so that the fuse sections of a bus bar closer to an inner side of the case entirely or mostly project farther than those of an adjacent bus bar closer to a peripheral wall of the case in the vertical direction. In other words, the distance is large enough to allow for a visual inspection of the entirety of the fuse sections of an adjacent inner bus bar over an upper edge of a bus bar closer to the peripheral wall. With such gaps between bus bars, the entirety of the fuse sections can be visually inspected through the gaps even if fuse sections of a bus bar closer to the inner side of the case overlap with a bus bar closer to the periphery case wall. Therefore, minimizing the distances and dimensions as much as possible prevents an electrical connection box from becoming large.

An aspect of the present invention provides an electrical connection box for housing a plurality of bus bars having integrally formed fusible links, the electrical connection box including a case configured to hold a plurality of bus bars vertically oriented and parallel to each other, the case including a peripheral wall; the bus bars positioned with vertical displacements therebetween such that a first outer bus bar closest to the peripheral wall of the case occupies a lower position and a second inner bus bar occupies a higher position; and a cover that closes an upper surface of the case; wherein the fuse sections of the bus bars can be visually inspected from the outside of the case. Further, wherein if a gap in a horizontal direction between the first and second bus bars is wide, the vertical displacement between the first and second bus bars is small; and if the gap is narrow, the vertical displacement between the first and second bus bars is large so that the fuse sections of the first bus bar project further than the fuse sections of the second bus bar. A further aspect of the present invention provides a cut out section provided on an upper edge of the peripheral wall of the case so that the position of the cut out section opposes the position of the fuse sections of the first outer bus bar at the lowest position. Further, the electrical connection box may include a third inner bus bar having integrally formed fusible links. Further, the third inner bus bar is positioned with a vertical displacement between the third inner bus bar and the second inner bus bar such that the second inner bus bar occupies a lower position and the third inner bus bar occupies a higher position.

A further aspect of the present invention provides a second peripheral wall in the case, the second peripheral wall parallel to the first peripheral wall; and a third outer bus bar having integrally formed fusible links, the third bus bar vertically oriented and parallel to the first and second-bus bars in the case, the third bus bar occupying a lower position adjacent the second peripheral wall, wherein the fuse sections of the third bus bar can be visually inspected from the outside of the case. The electrical connection box may further include a fourth inner bus bar having integrally formed fusible links, the fourth bus bar vertically oriented and parallel to the third outer bus bar, the bus bars positioned with vertical displacements therebetween such that the third outer bus bar closest to the second peripheral wall of the case occupies a lower position and the fourth inner bus bar occupies a higher position. Further, the box may include a cut out section provided on an upper edge of the second peripheral wall of the case so that the position of the cut out section opposes the position of the fuse sections of the third outer bus bar at the lowest position; the vertical position of the second inner bus bar is substantially equal to the vertical position of said fourth inner bus bar. Further, if a gap in a horizontal direction between the third and fourth bus bars is wide, the vertical displacement between the third and fourth bus bars is small; and if the gap is narrow, the vertical displacement between the third and fourth bus bars is large so that the fuse sections of the third bus bar project further than the fuse sections of the fourth bus bar.

### BRIEF DESCRIPTION OF THE DRAWINGS

The above, and other objects, features and advantages of the present invention will be made apparent from the following description of the preferred embodiments, given as nonlimiting examples, with reference to the accompanying drawings in which: FIG. 1 is a perspective view of an electrical connection box of a first embodiment of the present invention, showing the box;

FIG. 2 is a perspective view of the embodiment of FIG. 1 showing the bus bars housed within the case;

FIG. 3 is a cross sectional view of the embodiment of FIG. 1 showing the case covered with an upper cover;

FIG. 4 is a cross sectional view of an electrical connection box of a second embodiment of the present invention;

FIG. 5 is a cross sectional view of an electrical connection box of a third embodiment of the present invention;

FIG. 6 is a perspective view of a conventional bus bar; and

FIG. 7 is a cross sectional view of a conventional electrical connection box.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

Details of the present invention are described below with reference to the figures. FIGS. 1 through 3 depict an electrical connection box 10 of the first embodiment of the present invention. In this configuration, electrical connection box 10 houses two bus bars 20A, 20B in the case 11. The bus bars 20A, 20B include integrated fusible links. The upper opening of the case 11 is closed with cover 12; the lower surface is covered with lower cover 13; and locking projections 15 on lower cover 13 latch with locking receptacles 14 on upper cover 12 to lock the upper and lower covers together.

The two bus bars 20A and 20B may be formed by any suitable construction process such as, for example, integrally forming the bus bars 20A, 20B by stamping out a piece of a conductive metal plate, and providing an input terminal (not shown in the figure), a plurality of output terminals 22a and 22b, and a plurality of fuse sections 23a and 23b made of S-shaped narrow sections and positioned on the sides of the bus bar. The bus bars 20A and 20B may be molded with resin 24, except for a connection section of the input terminal, connection sections of output terminals 22a and 22b, and fuse sections 23a and 23b. Further, the mold may be made so that window openings 25 are provided through the walls from the inner to outer surfaces over sections corresponding to the fuse sections 23a and 23b, to expose fuse sections 23a and 23b.

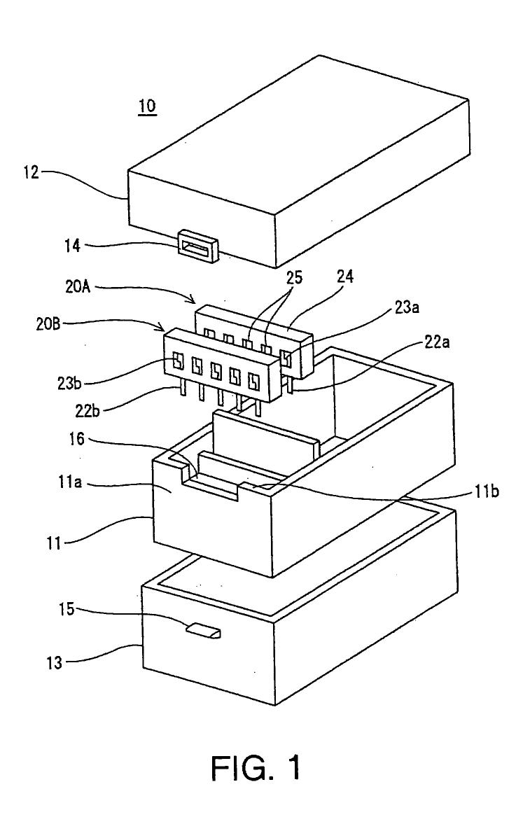

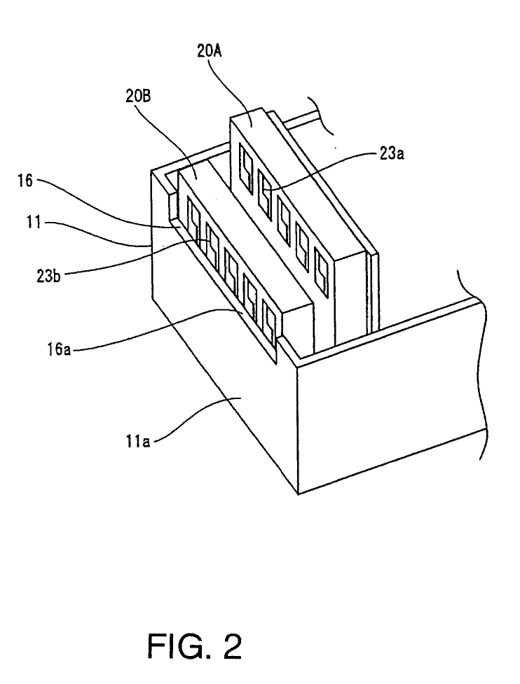

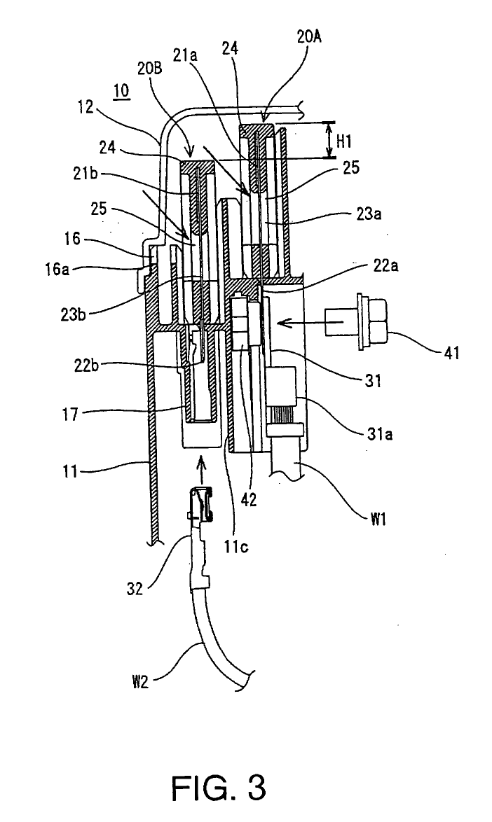

As illustrated in FIGS. 2 and 3, the bus bars 20A and 20B are inserted and mounted in the vertical orientation in the case 11 so that bus bars 20A and 20B are positioned in parallel alignment from the inner side of the case 11 to the side of peripheral wall 1a of the case. Moreover, the bus bars are arranged vertically so that bus bar 20B closer to peripheral wall 11a is placed at a lower position and inner bus bar 20A is placed at a higher position. The length H1 is the smallest required for a visual inspection of the entirety of fuse sections 23a of bus bar 20A over an upper edge of bus bar 20B closer to peripheral wall 11a. In the present embodiment, the length H1 is approximately the length for fuse sections 23a of bus bar 20A to entirely overlap bus bar 20B in the vertical direction.

Output terminals 22a of bus bar 20A housed in case 11 project toward the bottom surface of case 11. LA terminals 31 connected to the ends of wires W1 and output terminals 22a are fixed and connected with bolts 41 and nuts 42. Output terminals 22b of bus bar 20B housed closer to peripheral wall 1a project into cavity 17 formed on the bottom surface of case 11. Male terminals 32 which are connected to the sides of wires W₂ are inserted into and connected with output terminals 22b.

A cut-out section 16 is formed on upper edge 11b of peripheral wall 1a of the case 11, and its lower edge is provided at a location opposing fuse sections 23b of bus bar 20B housed at the lower position in said case 11 are located. In the present embodiment, lower edge 16a of cut-out section 16 is formed at a position which approximately opposes the center of fuse sections 23b as illustrated in FIG. 3. Moreover, between the bus bars 20A and 20B, dividing wall 11c is formed, extending from the upper to lower surface of the case 11. The dividing wall 11c extends to a position lower than pressure contact sections 31a of LA terminals 31 which are connected to output terminals 22a of the bus bar 20A.

With electrical connection box 10 with the configuration of the present invention, merely removing upper cover 12 facilitates an easy visual inspection of fuse sections 23a and 23b of bus bars 20A and 20B which are housed in case 11. In particular, providing a configuration so that bus bar 20A closer to the inner side of the case can be positioned higher than bus bar 20B closer to peripheral wall 11a enables the entirety of inner fuse sections 23a to be visually inspected from the direction indicated by arrows in FIG. 3. Therefore, fuse sections 23a and 23b can be visually inspected from the outside of the case with ease without taking either of two bus bars 20A and 20B out of case 11, thereby facilitating great improvements in the operation of determining whether or not any of fuse sections has blown. In addition, the quality of the electrical connection box of the present invention is improved since the terminals are prevented from deforming, which could occur in prior art technologies because of the removal of the bus bars to check for blown fuses.

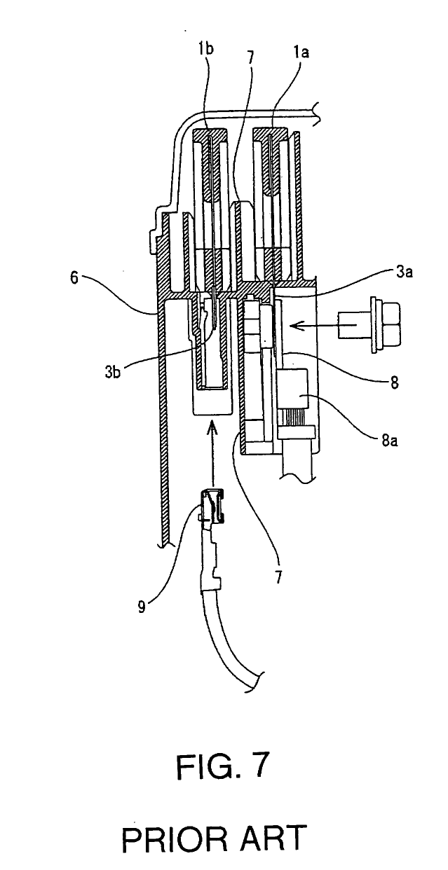

Further, in comparison to a conventional embodiment, such as is illustrated in FIG. 7 in which two bus bars integrated with fusible links are installed in parallel alignment without a vertical displacement, the present invention as illustrated in FIG. 3 enables dividing wall 11c to extend a shorter distance into cavity 17 into which output terminals 22b of bus bar 20B project. Therefore, the dividing wall 11c does not interfere with the insertion of male terminals 32 to output terminals 22b in the cavity 17 and the insertion can be performed with ease.

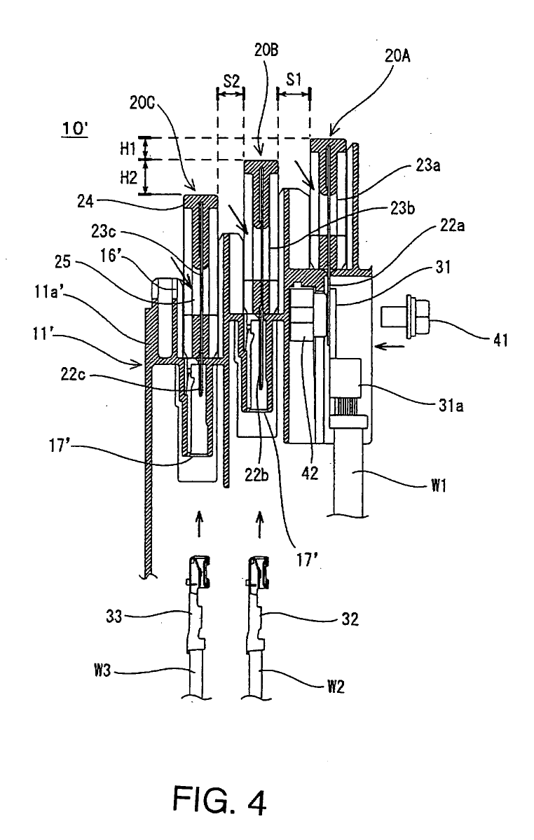

FIG. 4 illustrates the second embodiment of the present invention which provides electrical connection box 10′. The second embodiment differs from the first embodiment in that three bus bars 20A, 20B and 20C are provided in parallel alignment in the vertical orientation in case 11′. Other elements that are the same as in the first embodiment are designated by the same reference characters and descriptions thereof are is omitted.

The bus bar 20C has a similar configuration as bus bars 20A and 20B. Bus bar 20C may be formed integrally and in one piece by stamping out one piece of a conductive metal plate and providing an input terminal, a plurality of output terminals 22c and a plurality of fuse sections 23c made of S-shaped narrow sections together. Moreover, the bus bar 20C is molded with resin 24 except a connection section of the input terminal, connection sections of output terminals 22c and fuse sections 23c. The mold is made so that window openings 25 through the outer walls are formed over sections corresponding to the fuse sections 23c to expose fuse sections 23c.

As illustrated in FIG. 4, bus bars 20A, 20B and 20C are inserted and mounted in the vertical orientation in the case 11′ so that bus bars 20A, 20B and 20C are provided in parallel alignment from the inner side of the case 11′ to the side peripheral wall 11a′ of the case. Gap S1 between bus bars 20A and 20B is wider than gap S2 between bus bars 20B and 20C in order to obtain a space to accommodate nut 42 for connecting LA terminals 31 to output terminals 22a of bus bar 20A. Moreover, output terminals 22b and 22c of bus bar 20B and 20C, respectively, project into cavity 17′, where they are configured to be connected to male terminals 32 and 33 which are connected to wires W2 and W3, respectively.

Moreover, bus bars 20A, 20B and 20C are arranged with a vertical displacement of H2 between bus bars 20C and 20B and a vertical displacement of H1 between bus bars 20B and 20A, so that bus bar 20C which is the closest to peripheral wall 11a′ is placed at the lowest position and bus bars 20B and 20A are placed at respective higher and more inner positions. Displacement H1 is small and just sufficient for entire fuse sections 23a of bus bar 20A to overlap bus bar 20B in the vertical direction. Displacement H2 is larger than displacement H1 and is designed to have a length sufficient for approximately a half in the vertical direction of fuse sections 23b of bus bar 20B to extend over bus bar 20C.

A cut-out section 16′ is formed on peripheral wall 11a′ of case 11′, so that the position of cut-out section 16′ opposes fuse sections 23c of bus bar 20C at the lowest position in the case 11′.

In the present embodiment as well, three bus bars 20A, 20B and 20C are arranged with displacements such that the bus bar closest to the peripheral wall 11a′ is at the lowest position and that a more inner bus bar is at a higher position. Therefore, as illustrated by arrows in FIG. 4, even fuse sections 23a and 23b of inner bus bars 20A and 20B can be visually inspected from outside of the case without taking the bus bars out of case 11′. In particular, although gap S2 between bus bars 20B and 20C is narrower, displacement H2 is designed large enough to facilitate easy visual inspection of fuse section 23b diagonally from above over the upper edge of bus bar 20C. Further, gap S1 between bus bars 20B and 20A is wide. Thus, displacement H1 is designed as small as possible, so that a balance is kept between the size of electrical connection box 10′ and the ability to visually inspect the fuse sections from outside the case.

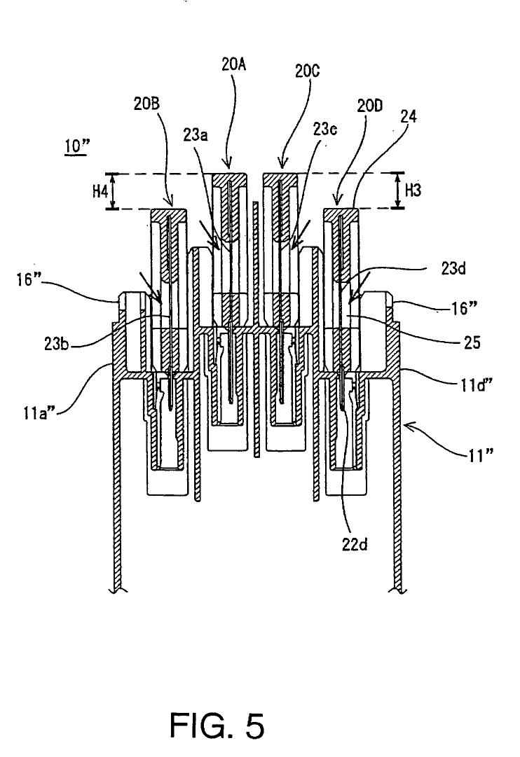

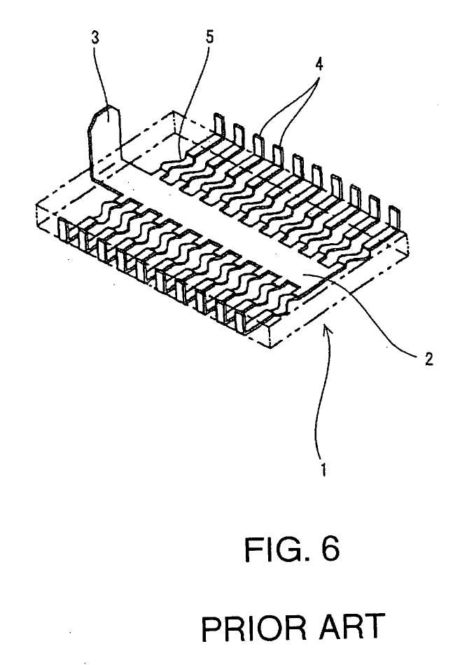

FIG. 5 illustrates electrical connection box 10″ of the third embodiment of the present invention. In case 11″, 4 bus bars 20A-20D are housed in the vertical orientation and provided in parallel alignment. Other elements that are the same as in the first embodiment are designated by the same reference characters and descriptions thereof are is omitted.

Bus bar 20D is made with the same configuration as that of bus bars 20A-20C. Bus bar 20D may be formed integrally and in one piece by stamping out a piece of a conductive metal plate, and providing an input terminal, a plurality of output terminals 22d, and a plurality of fuse sections 23d made of S-shaped narrow sections together. Moreover, the bus bar 20D is molded with resin 24 except for a connection section of the input terminal, connection sections of output terminals 22d, and fuse sections 23d. The mold is made so that window openings 25 through the inner to outer surfaces are formed over sections corresponding to the fuse sections 23d to expose fuse sections 23d.

Bus bars 20A-20D are installed in parallel alignment closer to one side of the case 1″. As illustrated in FIG. 5, bus bars 20B, 20A, 20C and 20D are housed in the vertical orientation in this order from peripheral walls 11a″ to 11d″ which oppose each other. Moreover, bus bars 20A-20D are arranged with vertical displacements H3 and H4 so that bus bars 20B and 20D closest to peripheral walls 10a″ and 11d″, respectively, are placed in the lowest position while inner bus bars 20A and 20C are placed at a higher position.

A cut-out section 16″ is formed on peripheral walls 11a″ and 11d″ of case 11″, respectively, which oppose each other. In further detail, cut-out section 16″ is formed on peripheral wall 11a″ so that the position of cut-out section 16″ opposes where fuse sections 23b of bus bar 20B housed at the lowest position in case 11″ are located. Cut-out section 16″ is formed on peripheral wall 11d″ so that the position of cut-out section 16″ opposes where fuse sections 23d of bus bar 20D housed at the lowest position in case 11″ are located.

In the present embodiment, among four bus bars 20A-20D housed in case 11″, bus bars 20B and 20D positioned on both sides are arranged closest to peripheral walls 11a″ and 11d″ opposing each other, respectively. Displacements are provided so that bus bars 20B and 20D positioned on both sides are placed at the lower position and that inner bus bars 20A and 20C are placed at the higher position. Therefore, in comparison to a case in which bus bars are placed at a higher position one by one from one side to the other side, the vertical difference between the highest and lowest positions can be made smaller and hence, upper case 12″ are made rather small and electrical connection box 10″ is prevented from becoming large. Moreover, fuse sections 23a of bus bar 20A can be visually inspected over the upper edge of bus bar 20B and fuse sections 23c of bus bar 20C can be visually inspected over the upper edge of bus bar 20D. Therefore, all four bus bars 20A-20D can be inspected to determine whether or not any of their fuse sections has blown without taking them out of case 11″.

As described above, according to the present invention, a bus bar integrated with fusible links closest to a peripheral case wall is placed at the lowest position and a displacement is provided so that an inner bus bar integrated with fusible links is placed at a higher position. Therefore, fuse sections of an inner bus bar integrated with fusible links can be visually inspected over an upper edge of an adjacent bus bar integrated with fusible links closer to a peripheral wall. Thus, fuse sections of a bus bar closest to a peripheral wall can be visually inspected with ease through a cut-out section formed on the peripheral wall and those of inner bus bars can be visually inspected according to the method above, in either case with ease and without taking the bus bars out of the case. Therefore, time and labor required to confirm whether or not any of the fusible sections have blown can be reduced. Moreover, terminal deformations due to pulling bus bars out of the case can be prevented, thereby improving the quality of the electrical connection box.

Further, when a gap between bus bars integrated with fusible links is wide, a displacement therebetween can be reduced, thereby providing a balance between the ability to visually inspect inner fuse sections from the outside and keeping the size of an electrical connection box in check.

Although the invention has been described with reference to an exemplary embodiment, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed. Rather, the invention extends to all functionally equivalent structures, methods, and uses such as are within the scope of the appended claims.

The present disclosure relates to subject matter contained in priority Japanese Application No. 2003-200248, filed on Jul. 23, 2003, which is herein expressly incorporated by reference in its entirety.

1. An electrical connection box for housing a plurality of bus bars having integrally formed fusible links, said electrical connection box comprising:
a case configured to hold a plurality of bus bars vertically oriented and parallel to each other, said case including a peripheral wall;
said bus bars positioned with vertical displacements therebetween such that a first outer bus bar closest to said peripheral wall of said case occupies a lower position and a second inner bus bar occupies a higher position; and
a cover that closes an upper surface of said case;
wherein said fuse sections of said bus bars can be visually inspected from the outside of said case.

2. The electrical connection box according to claim 1, wherein if a gap in a horizontal direction between said first and second bus bars is wide, the vertical displacement between said first and second bus bars is small; and if said gap is narrow, the vertical displacement between said first and second bus bars is large so that the fuse sections of said first bus bar project further than the fuse sections of said second bus bar.

3. The electrical connection box according to claim 1, further comprising:
a cut out section provided on an upper edge of said peripheral wall of said case so that the position of said cut out section opposes the position of said fuse sections of said first outer bus bar at the lowest position.

4. The electrical connection box according to claim 1, further comprising:
a third inner bus bar having integrally formed fusible links.

5. The electrical connection box according to claim 4, wherein said third inner bus bar is positioned with a vertical displacement between said third inner bus bar and said second inner bus bar such that said second inner bus bar occupies a lower position and said third inner bus bar occupies a higher position.

6. The electrical connection box according to claim 1, further comprising:
a second peripheral wall in said case, said second peripheral wall parallel to said first peripheral wall; and
a third outer bus bar having integrally formed fusible links, said third bus bar vertically oriented and parallel to said first and second bus bars in said case, said third bus bar occupying a lower position adjacent said second peripheral wall,
wherein said fuse sections of said third bus bar can be visually inspected from the outside of said case.

7. The electrical connection box according to claim 6, further comprising:
a fourth inner bus bar having integrally formed fusible links, said fourth bus bar vertically oriented and parallel to said third outer bus bar,
said bus bars positioned with vertical displacements therebetween such that said third outer bus bar closest to said second peripheral wall of said case occupies a lower position and said fourth inner bus bar occupies a higher position.

8. The electrical connection box according to claim 6, further comprising:
a cut out section provided on an upper edge of said second peripheral wall of said case so that the position of said cut out section opposes the position of said fuse sections of said third outer bus bar at the lowest position.

9. The electrical connection box according to claim 7, wherein the vertical position of said second inner bus bar is substantially equal to the vertical position of siad fourth inner bus bar.

10. The electrical connection box according to claim 7, wherein if a gap in a horizontal direction between said third and fourth bus bars is wide, the vertical displacement between said third and fourth bus bars is small; and if said gap is narrow, the vertical displacement between said third and fourth bus bars is large so that the fuse sections of said third bus bar project further than the fuse sections of said fourth bus bar.
